(19) United States
(12) Patent Application Publication
(10) Pub. No.: US 2026/0296641 A1
(43) Pub. Date: Oct. 1, 2026

(54) FLYING OBJECT

(71) Applicant: HONDA MOTOR CO., LTD., Tokyo (JP)

(72) Inventor: Yosuke Nakayama, Wako-shi (JP)

(21) Appl. No.: 19/631,595

(22) Filed: Mar. 27, 2026

(30) Foreign Application Priority Data
Mar. 28, 2025 (JP) 2025-055336

(51) Int. Cl. B64C 27/68; B64C 27/32; B64C 27/59; B64C 27/82; B64C 29/00; B64D 27/34; B64D 27/35; B64D 31/16; H02P 27/06

(52) U.S. Cl. CPC B64C 27/68; B64C 27/32; B64C 27/59; B64C 27/82; B64C 29/0016; B64D 27/34; B64D 27/35; B64D 31/16; H02P 27/06

(57) ABSTRACT

A flying object includes a rotation control unit and a lock control unit. The lock control unit locks a propeller in a state where the distal direction of one blade among a plurality of blades is set to a predetermined direction that is defined as a direction from the rear to the front of the flying object. An electrical angle when the distal direction of a first blade among the plurality of blades is set to the predetermined direction differs from an electrical angle when the distal direction of a second blade among the plurality of blades is set to the predetermined direction.

### CROSS-REFERENCE TO RELATED APPLICATIONS

This application is based upon and claims the benefit of priority from Japanese Patent Application No. 2025-055336 filed on Mar. 28, 2025, the contents of which are incorporated herein by reference.

### BACKGROUND OF THE INVENTION

### FIELD OF THE INVENTION

The present disclosure relates to a flying object.

### DESCRIPTION OF THE RELATED ART

JP 2024-020679 A discloses a power supply system for an aircraft. In this power supply system, direct-current (DC) power output from a power source is converted into alternating-current (AC) power by an inverter and the converted power is supplied to an AC motor.

### SUMMARY OF THE INVENTION

There is a need to appropriately supply electric power in a flying object (aerial vehicle).

The present disclosure has the object of satisfying the aforementioned need.

A first aspect of the present disclosure is a flying object equipped with a propeller configured to be rotated by an alternating-current motor, the propeller includes a plurality of blades having mutually different distal directions, each of the distal directions being defined as a direction from a proximal end of the blade toward a longitudinal distal end thereof, wherein the flying object includes a rotation control unit configured to perform rotation control, the rotation control being control that controls electric power supplied to the alternating-current motor to thereby rotate the propeller; and a lock control unit configured to perform lock control, the lock control being control that maintains a mechanical angle or an electrical angle of the alternating-current motor to thereby lock the propeller, wherein the lock control unit locks the propeller in a state where the distal direction of one blade of the plurality of blades is set to a predetermined direction, the predetermined direction being defined as a direction from a rear side of the flying object to a front side thereof, and wherein the electrical angle when the distal direction of a first blade of the plurality of blades is set to the predetermined direction differs from the electrical angle when the distal direction of a second blade of the plurality of blades is set to the predetermined direction.

A second aspect of the present disclosure is a flying object equipped with a propeller configured to be rotated by an alternating-current motor, the propeller including a plurality of blades, the flying object including: a rotation control unit configured to perform rotation control, the rotation control being control that controls electric power supplied to the alternating-current motor to thereby rotate the propeller; and a lock control unit configured to perform lock control, the lock control being control that maintains a mechanical angle or an electrical angle of the alternating-current motor to thereby lock the propeller, wherein the propeller has two or more mechanical angles at which air resistance acting on the propeller due to relative wind from a front side of an airframe of the flying object during cruising is minimized, and electrical angles respectively at which the propeller is locked at the two or more mechanical angles are all different from each other, and when the lock control is performed after completion of the lock control at a first mechanical angle among the two or more mechanical angles, the lock control unit performs the lock control at a second mechanical angle different from the first mechanical angle.

According to the present disclosure, it is possible to suitably supply electric power.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a flying object;

FIG. 2A is a schematic view of a propeller;

FIG. 2B is a schematic view of a propeller;

FIG. 3 is a schematic view of a power supply system;

FIG. 4 is a circuit diagram of a power supply circuit;

FIG. 5 is a circuit diagram of a power supply circuit;

FIG. 6 is a diagram illustrating a relationship between a mechanical angle, an electrical angle, and a propeller angle (propeller rotation angle) in a comparative example;

FIG. 7 is a vector diagram of three-phase currents in a comparative example;

FIG. 8 is a table showing a relationship between a mechanical angle, an electrical angle, and ratios of current flowing through respective phase circuits;

FIG. 9 is a diagram illustrating a relationship between a mechanical angle, an electrical angle, and a propeller angle in an embodiment;

FIG. 10 is a vector diagram of three-phase currents in an embodiment;

FIG. 11 is a vector diagram of three-phase currents in the embodiment;

FIG. 12 is a vector diagram of three-phase currents in the embodiment;

FIG. 13 is a vector diagram of three-phase currents in the embodiment;

FIG. 14 is a vector diagram of three-phase currents in the embodiment;

FIG. 15 is a table showing a relationship between a mechanical angle, an electrical angle, and ratios of current flowing through respective phase circuits;

FIG. 16 is a flowchart of a first temperature control process;

FIG. 17 is a flowchart of a second temperature control process; and

FIG. 18 is a diagram illustrating a relationship between a mechanical angle, an electrical angle, and a propeller angle in another embodiment.

### DETAILED DESCRIPTION OF THE INVENTION

In recent years, electric vertical take-off and landing aircraft (hereinafter, also referred to as "eVTOL aircraft") have been developed. The eVTOL aircraft includes a VTOL rotor (propeller) that generates upward thrust with respect to the airframe, and a cruise rotor (propeller) that generates forward thrust with respect to the airframe. When the eVTOL aircraft takes off and lands vertically and hovers, the VTOL rotor is mainly used. When the eVTOL aircraft is cruising, the cruise rotor is mainly used.

Typically, the VTOL rotor is not used when the eVTOL vehicle is cruising. The VTOL rotor is subjected to external force (air resistance) such as a headwind (relative wind) during cruising of the eVTOL aircraft. When the VTOL rotor rotates due to the external force or the like, there is a possibility that torque caused by the rotation of the VTOL rotor may be generated on the airframe. In order to avoid the above situation, it is preferable to lock the VTOL rotor during cruising of the eVTOL aircraft. As a means for locking the VTOL rotor, for example, there is a technique of electrically locking the alternating-current (AC) motor by generating a fixed magnetic field in the AC motor that rotates the VTOL rotor.

When the AC motor is caused to generate such a fixed magnetic field, electric current continuously flows through the same electrical components. This may cause those electrical components to overheat. In order to suppress overheating of the electrical components, it is conceivable to appropriately rotate the AC motor so as to change the mechanical angle at the time of locking.

However, even if the mechanical angle at the time of locking is changed, there are cases where overheating of the electrical components may not be suppressed. According to the present disclosure described below, overheating of the electrical components can be suppressed.

### 1. Flying Object 10

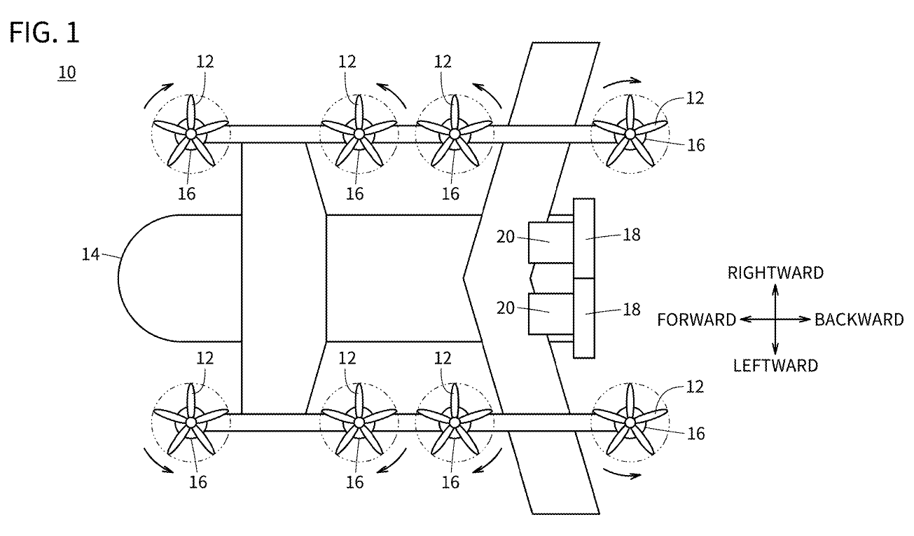

FIG. 1 is a schematic view of a flying object (aerial vehicle) 10. The flying object 10 is an eVTOL aircraft. The flying object 10 includes eight propellers 12. Each of the propellers 12 is a VTOL rotor. The propeller 12 generates upward thrust with respect to the airframe 14. The flying object 10 includes eight electric motors 16. One electric motor 16 drives one propeller 12. The flying object 10 includes two propellers 18. Each of the propellers 18 is a cruise rotor. The propeller 18 generates forward thrust with respect to the airframe 14. The flying object 10 includes two electric motors 20. One electric motor 20 drives one propeller 18.

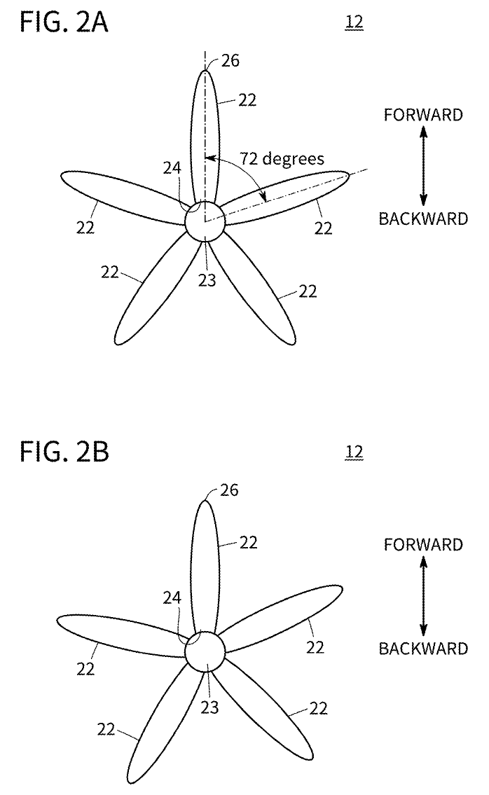

FIG. 2A is a schematic view of the propeller 12. The propeller 12 includes a plurality of blades 22. Here, the propeller 12 with five blades 22 is assumed. The five blades 22 are arranged at equal angular intervals around a hub 23. The angle between two adjacent blades 22 is 72 degrees. The five blades 22 have mutually different distal directions (tip directions), each of the distal directions being defined a direction from the proximal end (blade root) 24 toward the longitudinal distal end (blade tip) 26. As shown in FIG. 2B, the five blades 22 need not be arranged at equal angular intervals. That is, the five blades 22 may be arranged at unequal angular intervals.

### 2. Power Supply System 30

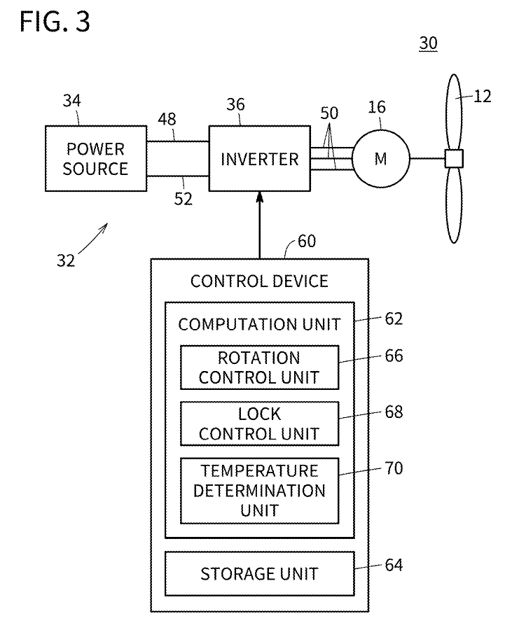

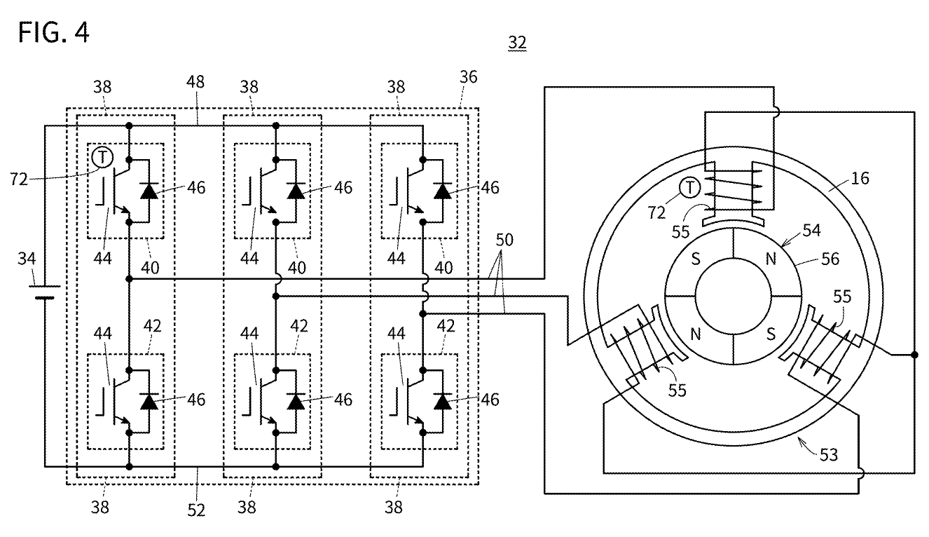

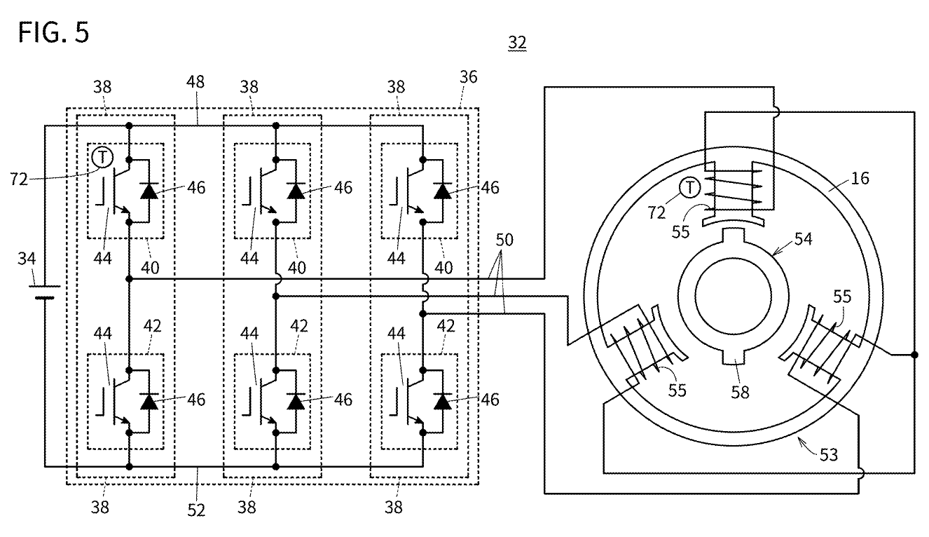

FIG. 3 is a schematic view of a power supply system 30. FIGS. 4 and 5 are circuit diagrams of a power supply circuit 32. The power supply system 30 is included in the flying object 10. As shown in FIG. 3, the power supply system 30 includes the power supply circuit 32 and a control device 60.

### 2-1. Power Supply Circuit

As shown in FIG. 4, the power supply circuit 32 includes a power source 34, an inverter 36, and the electric motor 16. The power supply circuit 32 is a three-phase AC circuit.

The power source 34 includes at least one of a power generation device or a power storage device (neither of which is shown). The power generation device includes an engine, a power generator, and an AC-DC converter (none of which is shown). The power generator is driven by an engine or the like. The AC-DC converter converts AC power output from the power generator into DC power and outputs the DC power. The power storage device includes a storage battery (not shown) such as a lithium ion battery.

The inverter 36 is a multi-phase inverter including phase circuits of a U-phase, a V-phase, and a W-phase. The inverter 36 includes three power element units 38. Each power element unit 38 is provided in one of the U-phase, V-phase, and W-phase circuits. The three power element units 38 have the same configuration.

The power element unit 38 includes an upper arm 40 and a lower arm 42. Each of the upper arm 40 and the lower arm 42 includes a switching element 44 and a diode 46. In the power element unit 38, the switching element 44 of the upper arm 40 and the switching element 44 of the lower arm 42 are connected in series with each other. A first end of the switching element 44 of the upper arm 40 is connected to a positive wiring 48 of the power supply circuit 32. A second end of the switching element 44 of the upper arm 40 and a first end of the switching element 44 of the lower arm 42 are connected to one of the three-phase wirings 50. A second end of the switching element 44 of the lower arm 42 is connected to a negative wiring 52 of the power supply circuit 32. The anode of the diode 46 is connected to the second end of the switching element 44. A cathode of the diode 46 is connected to a first end of the switching element 44.

The electric motor 16 is a three-phase AC motor (multi-phase motor) including phase circuits of a U-phase, a V-phase, and a W-phase. The electric motor 16 includes a stator 53 and a rotor 54. The electric motor 16 may be of an inner rotor type or an outer rotor type. The stator 53 is provided with three-phase coils 55. Each coil 55 is provided in one of the U-phase, V-phase, and W-phase circuits.

As shown in FIG. 4, the rotor 54 includes a plurality of magnets 56. That is, the rotor 54 includes a plurality of pole pairs. The number of pole pairs is a non-integer multiple of the number of blades 22. Accordingly, when the propeller 12 is locked, it is possible to suppress overheating of the electrical components (the switching elements 44, the coils 55, and the like) included in each of the phase circuits.

As shown in FIG. 5, the rotor 54 may include a plurality of salient poles 58 instead of the plurality of magnets 56. In this case, the number of salient poles 58 is a non-integer multiple of the number of blades 22. Accordingly, when the propeller 12 is locked, it is possible to suppress overheating of the electrical components included in each of the phase circuits.

### 2-2. Control Device 60

As shown in FIG. 3, the control device 60 includes a computation unit 62 and a storage unit 64. The control device 60 is configured by, for example, an electronic control unit ECU.

The computation unit 62 is, for example, a processor such as a central processing unit (CPU), a graphics processing unit (GPU), or the like. The computation unit 62 includes a rotation control unit 66, a lock control unit 68, and a temperature determination unit 70. The rotation control unit 66, the lock control unit 68, and the temperature determination unit 70 are realized by the computation unit 62 executing a program stored in the storage unit 64. At least a part of the rotation control unit 66, the lock control unit 68, and the temperature determination unit 70 may be realized by an integrated circuit such as an application specific integrated circuit (ASIC) or a field-programmable gate array (FPGA). At least a part of the rotation control unit 66, the lock control unit 68, and the temperature determination unit 70 may be realized by an electronic circuit including a discrete device.

The storage unit 64 is a computer-readable non-transitory tangible storage medium. The storage unit 64 includes a volatile memory (not illustrated) and a non-volatile memory (not illustrated). The volatile memory is, for example, a random access memory (RAM). The non-volatile memory is, for example, a read only memory (ROM), a flash memory, or the like. Data and the like are stored in, for example, the volatile memory. Programs, tables, maps, and the like are stored, for example, in the non-volatile memory. At least a part of the storage unit 64 may be included in the processor, the integrated circuit, or the like as described above.

The rotation control unit 66 controls electric power supplied to the electric motor 16 to rotate the propeller 12. This control is referred to as rotation control. The rotation control unit 66 generates a rotating magnetic field by the rotation control. The rotation control unit 66 switches on and off each switching element 44 of the inverter 36.

The lock control unit 68 controls electric power supplied to the electric motor 16 to lock the propeller 12. This control is referred to as lock control. The lock control unit 68 generates a fixed magnetic field by the lock control. The lock control unit 68 switches the switching elements 44 of the inverter 36 between on and off while maintaining the electrical angle of the electric motor 16.

Specifically, the lock control unit 68 performs the lock control in a state where the distal direction of one blade 22 among the plurality of blades 22 is set to a predetermined direction (forward direction) that is a direction from the rear side to the front side of the flying object 10. In other words, the lock control unit 68 performs the lock control in a state where the distal end 26 of one blade 22 among the plurality of blades 22 is oriented forward. This makes it possible to reduce the air resistance caused by a headwind acting on the propeller 12 during cruising of the flying object 10.

The temperature determination unit 70 determines the temperature of each of the plurality of phase circuits. For example, each phase circuit includes electrical components such as the switching elements 44 of the inverter 36, the coils 55 of the electric motor 16, and the like. As shown in FIG. 4, a temperature sensor 72 is disposed in the vicinity of each electrical component. The temperature determination unit 70 determines the temperature of each electrical component based on the temperature detected by each temperature sensor 72. In FIG. 4, some of the temperature sensors 72 are omitted.

### 3. Comparison between Present Disclosure and Comparative Example

As described above, in the present disclosure, the number of pole pairs (or salient poles 58, omitted below) included in the rotor 54 is a non-integer multiple of the number of blades 22. Hereinafter, a difference between a comparative example in which the number of pole pairs provided in the rotor 54 is an integral multiple of the number of blades 22 and the present disclosure will be described. In the comparative example described below, the number of blades 22 is five, and the number of pole pairs is 20. In one embodiment of the present disclosure described below, the number of blades 22 is five, and the number of pole pairs is 24.

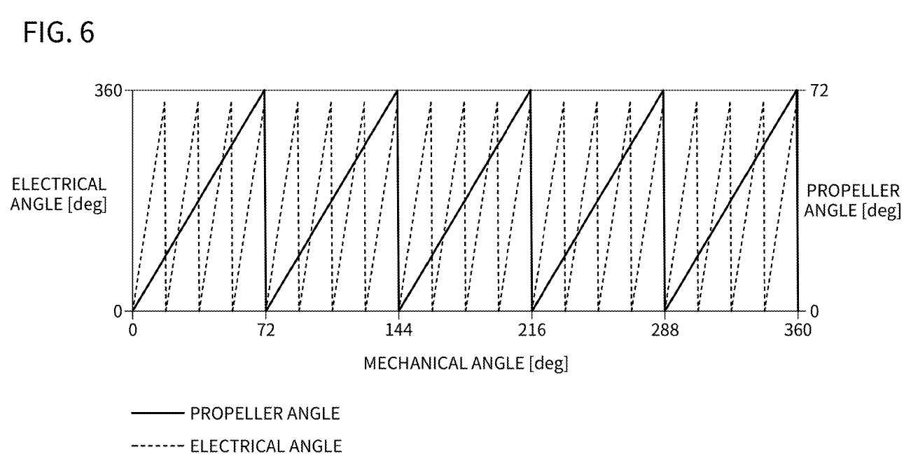

FIG. 6 is a diagram illustrating a relationship between a mechanical angle, an electrical angle, and a propeller angle (i.e., propeller rotation angle) in a comparative example. FIG. 6 relates to the rotation angle of the propeller 12 with the five blades 22 arranged at equal angular intervals, and also relates to the rotation angle of the electric motor 16. FIG. 6 shows the electrical angle (left vertical axis) and the propeller angle (right vertical axis) with respect to the mechanical angle (horizontal axis) during one rotation of the rotation shaft of the electric motor 16. The mechanical angle indicates a rotation angle of the rotation shaft of the electric motor 16. The electrical angle indicates the angle of the rotating magnetic field of the electric motor 16 in cycles of 360 degrees. The propeller angle indicates the rotation angle of the propeller 12 in cycles of 72 degrees. One cycle of the propeller angle is calculated by [mechanical angle of one rotation of the rotation shaft (= 360)] / [number of blades (= 5)]. The angle of 72 degrees is the angle between two adjacent blades 22. In the comparative example, a state where the distal end 26 of one blade 22 of the five blades 22 is oriented forward is defined as the initial state of the propeller 12. In the initial state, each of the mechanical angle, the electrical angle, and the propeller angle is zero.

As described above, when the propeller 12 is locked in a state where the distal end 26 of one blade 22 among the plurality of blades 22 is oriented forward during cruising of the flying object 10, resistance such as a headwind acting on the propeller 12 is reduced. In the propeller 12 including the five blades 22, when the mechanical angle is set to 0 degrees (= 360 degrees), 72 degrees, 144 degrees, 216 degrees, and 288 degrees, the distal end 26 of one of the blades 22 is oriented forward. As shown in FIG. 6, in the comparative example, when the mechanical angle is set to 0 degrees, the propeller angle is 0 degrees and the electrical angle is 0 degrees. Further, in the comparative example, even when the mechanical angle is set to 72 degrees, 144 degrees, 216 degrees, and 288 degrees, the propeller angle is 0 degrees and the electrical angle is 0 degrees. That is, in the comparative example, when the propeller angle is set to 0 degrees in the lock control, the electrical angle is always 0 degrees. In other words, in the comparative example, the electrical angle remains at 0 degrees even when the mechanical angle is set to any of 0 degrees, 72 degrees, 144 degrees, 216 degrees, or 288 degrees, in the lock control.

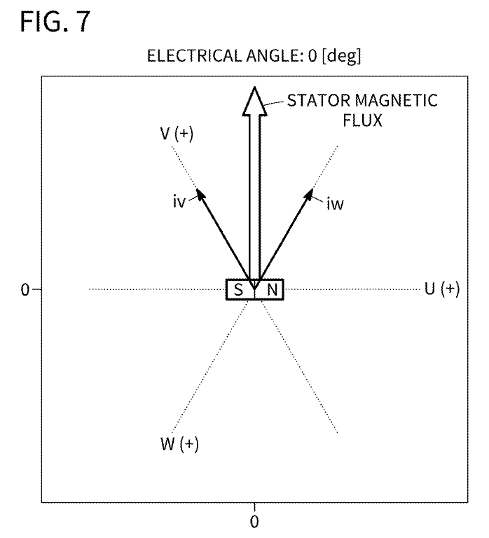

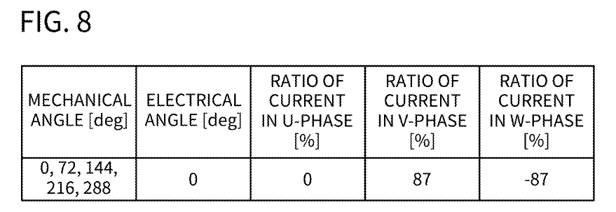

FIG. 7 is a vector diagram of three-phase currents in the comparative example. As shown in FIG. 7, the magnitudes of the three-phase currents are determined such that the stator magnetic flux is generated in a direction in which the magnet torque produced by the magnet 56 of the electric motor 16 is maximized, for example. FIG. 8 is a table showing a relationship between the mechanical angle, the electrical angle, and the ratios of current flowing through the phase circuits. The greater the ratio of current flowing through the phase circuit, the larger the amount of heat generated in the electrical components provided in the phase circuit becomes.

In the comparative example, the three-phase currents are in the same state regardless of whether the mechanical angle is set to 0 degrees, 72 degrees, 144 degrees, 216 degrees, or 288 degrees. In the case of the comparative example, during the lock control, electric current continuously flows through the V-phase circuit and the W-phase circuit. Therefore, in the case of the comparative example, there is a possibility that the electrical components included in the V-phase circuit and the W-phase circuit may be overheated.

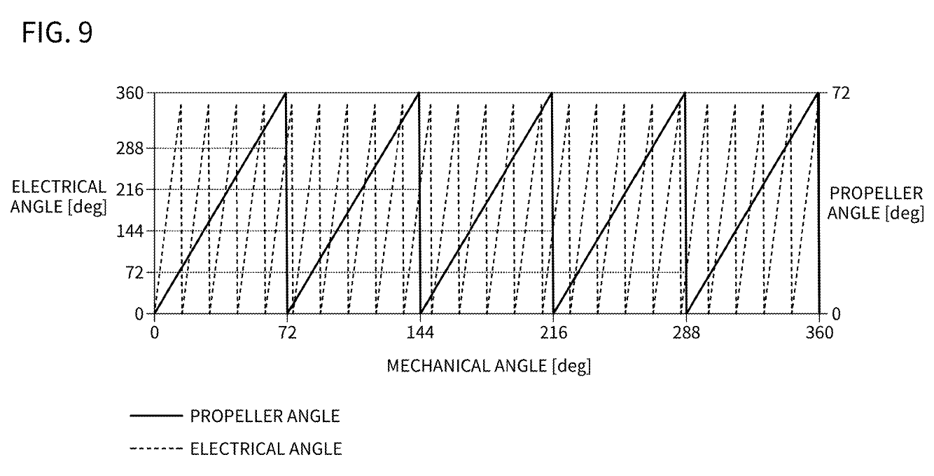

FIG. 9 is a diagram illustrating a relationship between the mechanical angle, the electrical angle, and the propeller angle in an embodiment. FIG. 9 relates to the rotation angle of the propeller 12 with the five blades 22 arranged at equal angular intervals, and also relates to the rotation angle of the electric motor 16. As shown in FIG. 9, in the embodiment, when the mechanical angle is set to 0 degrees, the electrical angle is 0 degrees. In the embodiment, when the mechanical angle is set to 72 degrees, the propeller angle is 0 degrees and the electrical angle is 288 degrees. In the embodiment, when the mechanical angle is set to 144 degrees, the propeller angle is 0degrees and the electrical angle is 216 degrees. In the embodiment, when the mechanical angle is set to 216 degrees, the propeller angle is 0 degrees and the electrical angle is 144 degrees. In the embodiment, when the mechanical angle is set to 288 degrees, the propeller angle is 0 degrees and the electrical angle is 72 degrees. As described above, in the embodiment, the electrical angle when the distal direction (tip direction) of the first blade among the plurality of blades 22 is set to the predetermined direction (i.e., the propeller angle is 0 degrees) differs from the electrical angle when the distal direction of the second blade among the plurality of blades 22 is set to the predetermined direction (i.e., the propeller angle is 0 degrees).

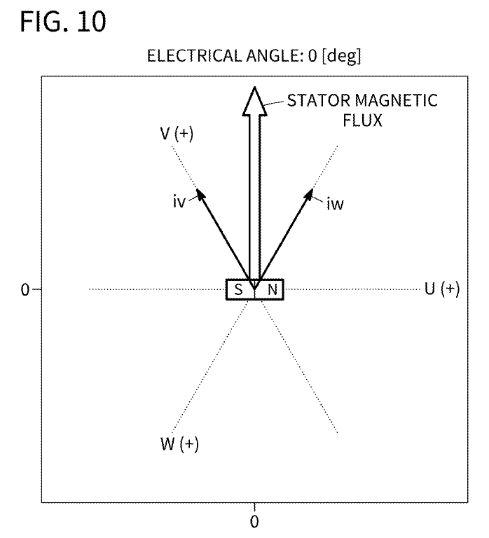

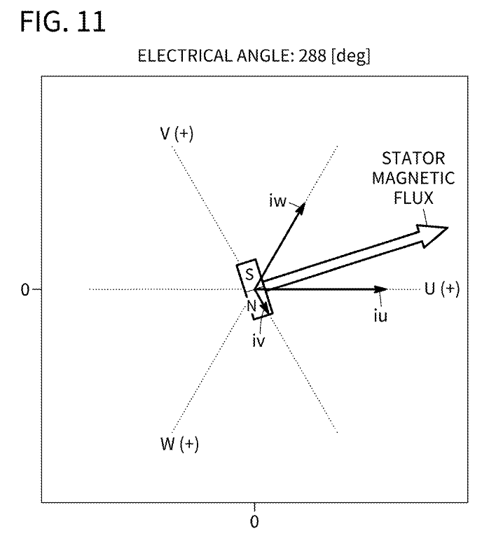

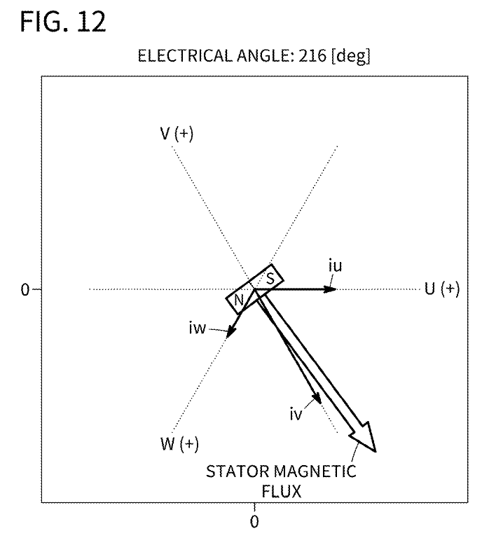

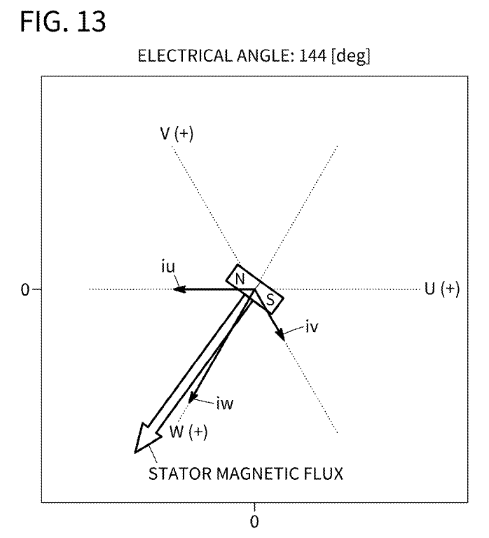

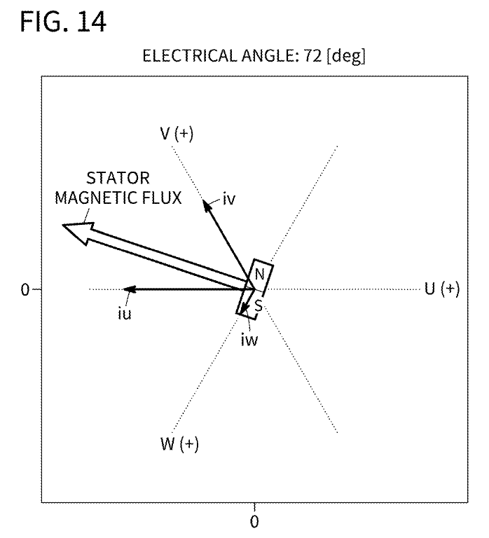

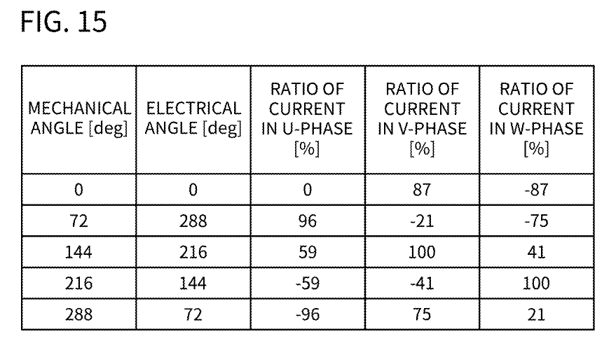

FIGS. 10 to 14 are vector diagrams of three-phase currents in the embodiment. As shown in FIGS. 10 to 14, the magnitudes of the three-phase currents are determined such that the stator magnetic flux is generated in a direction in which the magnet torque produced by the magnet 56 of the electric motor 16 is maximized, for example. FIG. 10 shows a vector diagram of the three-phase currents when the electrical angle is 0 degrees. FIG. 11 shows a vector diagram of the three-phase currents when the electrical angle is 288 degrees. FIG. 12 shows a vector diagram of the three-phase currents when the electrical angle is 216 degrees. FIG. 13 shows a vector diagram of the three-phase currents when the electrical angle is 144 degrees. FIG. 14 shows a vector diagram of the three-phase currents when the electrical angle is 72 degrees. FIG. 15 is a table showing a relationship between the mechanical angle, the electrical angle, and the ratios of currents flowing through the phase circuits. The greater the ratio of current flowing through the phase circuit, the larger the amount of heat generated in the electrical components provided in the phase circuit becomes.

In the embodiment, as shown in FIGS. 10 to 15, when the set mechanical angle changes, the state of the three-phase currents also changes. In the embodiment, the mechanical angle and the state of the three-phase currents correspond to each other on a one-to-one basis. When the propeller 12 is locked in a state where the distal direction (tip direction) of the first blade is oriented in a predetermined direction, the amount of heat generated in one phase circuit among the plurality of phase circuits is maximized. When the propeller 12 is locked in a state where the distal direction of the second blade is oriented in the predetermined direction, the amount of heat generated in another phase circuit among the plurality of phase circuits is maximized. As shown in FIG. 15, for example, when the electrical angle is 0 degrees (the mechanical angle is 0 degrees), the amount of heat generated in the electrical components of the V-phase circuit and the W-phase circuit is maximized. On the other hand, when the electrical angle is 288 degrees (the mechanical angle is 72 degrees), the amount of heat generated in the electrical components of the U-phase circuit is maximized.

In the embodiment, during the lock control, the heat generation state of each electrical component can be changed by changing the mechanical angle from one mechanical angle (a first mechanical angle) to another mechanical angle (a second mechanical angle) among the five mechanical angles. According to the embodiment, by appropriately changing the mechanical angle such that the propeller angle becomes 0 degrees, it is possible to suppress overheating of each electrical component due to the lock control.

### 4. Temperature Control Process

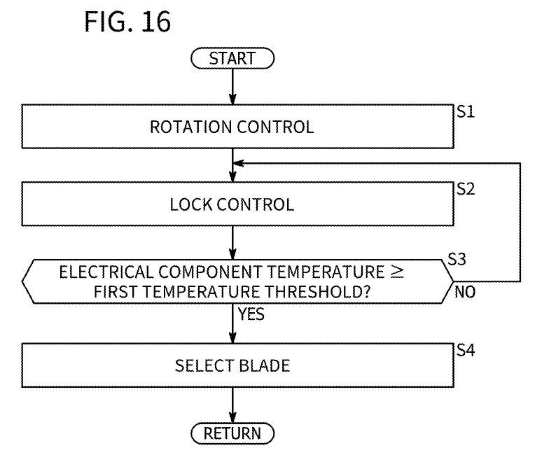

FIG. 16 is a flowchart of a first temperature control process. The first temperature control process is performed during cruising of the flying object 10.

In step S1, the rotation control unit 66 performs rotation control so as to position one of the plurality of blades 22 in the forward direction. In step S1 performed for the first time after the start of the temperature control process, the blade 22 to be positioned in the forward direction is arbitrarily selected. After the start of the temperature control process, in step S1 performed for the second time and thereafter, the blade 22 to be positioned in the forward direction is selected in step S4 described later.

In step S2, the lock control unit 68 performs the lock control in a state where the distal end 26 of the selected blade 22 is oriented toward the front.

In step S3, the temperature determination unit 70 compares the temperature of each of the electrical components detected by the temperature sensors 72 with a first temperature threshold. The first temperature threshold is stored in advance in the storage unit 64. The first temperature threshold is determined for each electrical component. When the temperature of any one of the electrical components is equal to or higher than the first temperature threshold (step S3: YES), the process proceeds to step S4. On the other hand, when the temperatures of all of the electrical components are lower than the first temperature thresholds (step S3: NO), the process returns to step S2. In this case, the lock control is continued.

In step S4, the rotation control unit 66 selects a blade 22 to be positioned in the forward direction by the rotation control to be performed next. For example, the rotation control unit 66 selects a blade 22 to be positioned in the forward direction in a manner so that the amount of heat generated in the phase circuit having the maximum heat generation at that time becomes minimized.

A specific example will be described with reference to FIG. 15. For example, when the lock control is performed in a state where the electrical angle is 288 degrees (the mechanical angle is 72 degrees), the amount of heat generated in the electrical components of the U-phase circuit becomes the maximum. On the other hand, when the lock control is performed in a state where the electrical angle is 0 degrees (the mechanical angle is 0 degrees), the amount of heat generated in the electrical components of the U-phase circuit becomes minimized. In this example, when the lock control unit 68 performs the lock control with the mechanical angle set to 72 degrees (electrical angle: 288 degrees), the rotation control unit 66 may perform the rotation control to set the next mechanical angle to 0 degrees (electrical angle: 0 degrees). This minimizes electric current flowing through the U-phase circuit, and accordingly minimizes the amount of heat generated in the electrical components.

In the case of FIG. 15, when the lock control unit 68 performs the lock control with the mechanical angle set to 72 degrees (electrical angle: 288 degrees), the rotation control unit 66 may perform the rotation control to set the next mechanical angle to 144 degrees (electrical angle: 216 degrees) or 216 degrees (electrical angle: 144 degrees). This reduces electric current flowing through the U-phase circuit, and accordingly reduces the amount of heat generated in the electrical components.

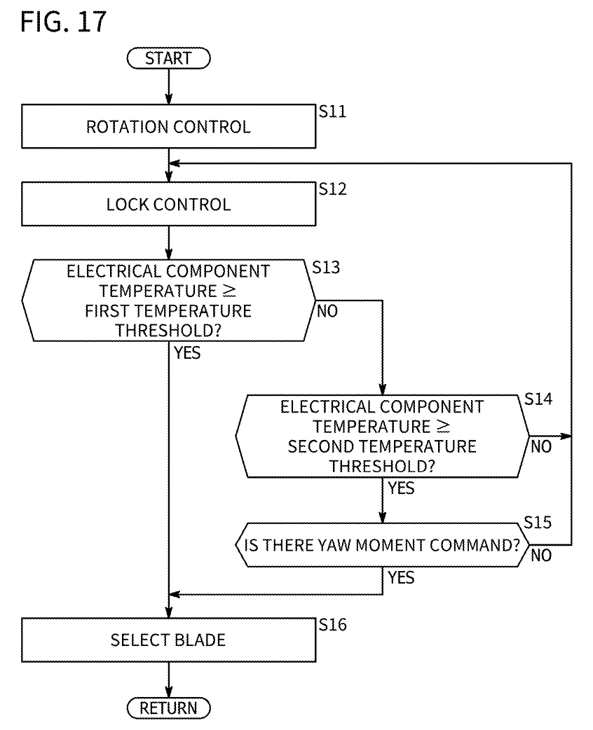

FIG. 17 is a flowchart of a second temperature control process. Instead of the first temperature control process, the second temperature control process may be performed. Step S11 to step S13 and step S16 illustrated in FIG. 17 are the same as step S1 to step S4 illustrated in FIG. 16. Hereinafter, processes (step S14 and step S15) newly added to the first temperature control process will be described.

When the process proceeds from step S13 to step S14, the temperature determination unit 70 compares the temperature of each of the electrical components detected by the temperature sensors 72 with a second temperature threshold. The second temperature threshold is lower than the first temperature threshold. The second temperature threshold is stored in the storage unit 64 in advance. The second temperature threshold is determined for each electrical component. If the temperature of any one of the electrical components is equal to or higher than the second temperature threshold (step S14: YES), the process proceeds to step S15. On the other hand, when the temperatures of all of the electrical components are less than the second temperature thresholds (step S14: NO), the process returns to step S12. In this case, the lock control is continued.

When the process proceeds from step S14 to step S15, the rotation control unit 66 determines whether or not there is a yaw moment command for generating a yaw moment. The yaw moment command is issued from an external management ECU (not shown) that controls the system of the flying object 10. When there is a yaw moment command (step S15: YES), the process proceeds to step S16. On the other hand, when there is no yaw moment command (step S15: NO), the process returns to step S12. In this case, the lock control is continued.

### 5. Others

### 5-1. Other Embodiments

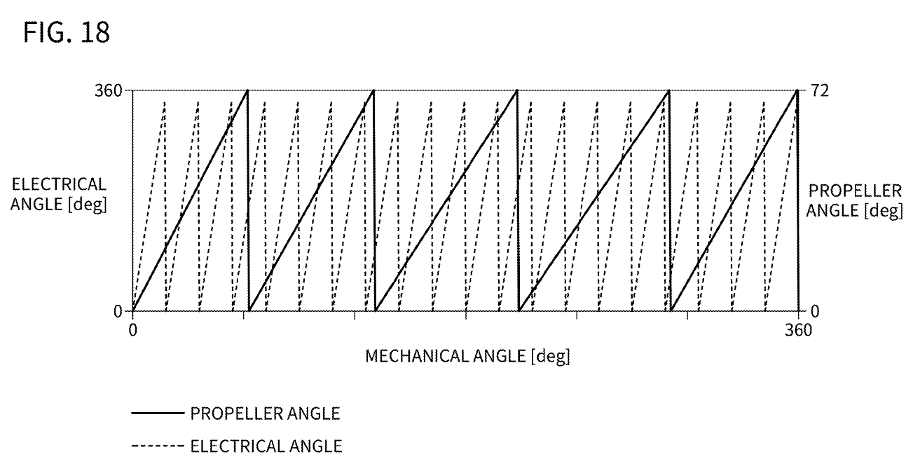

As shown in FIG. 2B, the five blades 22 may be arranged at unequal angular intervals. As shown in FIG. 18, in another embodiment, the electrical angle obtained when the distal direction (tip direction) of the first blade among the plurality of blades 22 is set to the predetermined direction (i.e., the propeller angle: 0 degrees) differs from the electrical angle when the distal direction of the second blade among the plurality of blades 22 is set to the predetermined direction (i.e., the propeller angle: 0 degrees).

### 5-2. Application Examples

The rotation control unit 66 may perform rotation control to rotate the propeller 12 in a first direction and, at the same time, rotate another propeller 12 in a direction opposite to the first direction. Accordingly, torque acting on the airframe 14 when the propeller 12 is rotated in the first direction can be canceled out by torque acting on the airframe 14 when the other propeller 12 is rotated in the second direction.

### 6. Supplementary Notes

The following Supplementary Notes are further disclosed in relation to the above embodiments.

### Supplementary Note 1

The flying object (10) of the present disclosure is the flying object including the propeller (12) rotated by the alternating-current (AC) motor (16), the propeller including the plurality of blades (22) having mutually different tip directions (distal directions), each of the distal directions being defined as the direction from the proximal end (24) of the blade toward the longitudinal distal end (26) thereof. The flying object includes the rotation control unit (66) that performs rotation control, which is control that controls electric power supplied to the AC motor to thereby rotate the propeller, and the lock control unit (68) that performs lock control, which is control that maintains the mechanical angle or the electrical angle of the AC moto to thereby lock the propeller. The lock control unit locks the propeller in a state where the distal direction of one of the plurality of blades is set to the predetermined direction, which is defined as a direction from the rear side to the front side of the flying object, and the electrical angle when the distal direction of the first blade of the plurality of blades is set to the predetermined direction differs from the electrical angle when the distal direction of the second blade of the plurality of blades is set to the predetermined direction.

According to the above configuration, it is possible to suppress overheating of each electrical component caused by the lock control.

### Supplementary Note 2

In the flying object according to Supplementary Note 1, the plurality of blades may be arranged at equal angular intervals, the AC motor may include the rotor (54) including the plurality of pole pairs, and the number of the pole pairs may be a non-integer multiple of the number of the blades.

### Supplementary Note 3

In the flying object according to Supplementary Note 1, the plurality of blades may be arranged at equal angular intervals, the alternating-current motor may include the rotor including the plurality of salient poles (58), and the number of the salient poles may be a non-integer multiple of the number of the blades.

### Supplementary Note 4

In the flying object according to Supplementary Note 1, the AC motor may be a multi-phase motor; the multi-phase motor may be driven by the multi-phase inverter including the plurality of phase circuits; the flying object may further include the temperature determination unit (70) configured to determine the temperature of each of the plurality of phase circuits; and when the propeller is locked in a state where the distal direction of the first blade is set to the predetermined direction, in a case where the temperature determination unit determines that the temperature of any one of the plurality of phase circuits is equal to or higher than the predetermined first temperature threshold, the rotation control unit may perform the rotation control to thereby set the distal direction of the second blade to the predetermined direction, and the lock control unit may lock the propeller in a state where the distal direction of the second blade is set to the predetermined direction.

### Supplementary Note 5

In the flying object according to Supplementary Note 4, in a case where a command to generate a yaw moment is issued when the propeller is locked in the state where the distal direction of the first blade is set to the predetermined direction, and in a case where the temperature determination unit determines that the temperature of any one of the plurality of phase circuits is equal to or higher than the second temperature threshold even in a case where the temperature determination unit determines that the temperatures of all of the plurality of phase circuits are lower than the first temperature threshold, the rotation control unit may perform the rotation control to thereby set the distal direction of the second blade to the predetermined direction and the lock control unit may lock the propeller in the state where the distal direction of the second blade is set to the predetermined direction, the second temperature threshold being lower than the first temperature threshold.

### Supplementary Note 6

In the flying object according to Supplementary Note 4 or 5, when the propeller is locked in the state where the distal direction of the first blade is set to the predetermined direction, the amount of heat generated in one phase circuit among the plurality of phase circuits may be maximized, and when the propeller is locked in the state where the distal direction of the second blade is set to the predetermined direction, the amount of heat generated in another phase circuit different from the one phase circuit among the plurality of phase circuits may be maximized.

### Supplementary Note 7

In the flying object according to Supplementary Note 6, the rotation control unit may set the distal direction of one of the plurality of blades to the predetermined direction in a manner so that the amount of heat generated in a phase circuit having a largest heat generation amount among the plurality of phase circuits is minimized.

### Supplementary Note 8

In the flying object according to Supplementary Note 1, the rotation control unit may perform the rotation control to rotate the propeller and, at the same time, perform control to rotate another propeller in a direction opposite to the rotation direction of the propeller, to thereby cancel out torque.

### Supplementary Note 9

In the flying object according to Supplementary Note 1, the plurality of blades may be arranged at unequal angular intervals.

### Supplementary Note 10

The flying object of the present disclosure is the flying object including the propeller configured to be rotated by the AC motor, the propeller including a plurality of blades, the flying object including: the rotation control unit configured to perform rotation control, the rotation control being control that controls electric power supplied to the AC motor to thereby rotate the propeller; and the lock control unit configured to perform lock control, the lock control being control that maintains the mechanical angle or the electrical angle of the alternating-current motor to thereby lock the propeller, wherein the propeller has two or more mechanical angles at which air resistance acting on the propeller due to relative wind from the front side of the airframe (14) of the flying object during cruising is minimized, and electrical angles respectively at which the propeller is locked at the two or more mechanical angles are all different from each other, and when the lock control is performed after completion of the lock control at the first mechanical angle of the two or more mechanical angles, the lock control unit performs the lock control at the second mechanical angle different from the first mechanical angle.

Although the present disclosure has been described in detail, the present disclosure is not limited to the above-described embodiments. In these embodiments, various addition, replacement, changing, partial deletions, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. A flying object comprising:
a propeller configured to be rotated by an alternating-current motor; and
a control device including one or more processors that execute computer-executable instructions stored in a memory,
wherein the propeller includes a plurality of blades having mutually different distal directions, each of the distal directions being defined as a direction from a proximal end of the blade toward a longitudinal distal end of the blade,
wherein the one or more processors execute the computer-executable instructions to cause the control device to:
perform rotation control, the rotation control being control that controls electric power supplied to the alternating-current motor to thereby rotate the propeller; and
perform lock control, the lock control being control that maintains a mechanical angle or an electrical angle of the alternating-current motor to thereby lock the propeller,
wherein the one or more processors cause the control device to lock the propeller in a state where the distal direction of one blade of the plurality of blades is set to a predetermined direction, the predetermined direction being defined as a direction from a rear side of the flying object to a front side of the flying object, and
wherein the electrical angle when the distal direction of a first blade of the plurality of blades is set to the predetermined direction differs from the electrical angle when the distal direction of a second blade of the plurality of blades is set to the predetermined direction.

2. The flying object according to claim 1, wherein
the plurality of blades are arranged at equal angular intervals,
the alternating-current motor includes a rotor including a plurality of pole pairs, and
a number of the pole pairs is a non-integer multiple of a number of the blades.

3. The flying object according to claim 1, wherein
the plurality of blades are arranged at equal angular intervals,
the alternating-current motor includes a rotor including a plurality of salient poles, and
a number of the salient poles is a non-integer multiple of a number of the blades.

4. The flying object according to claim 1, wherein
the alternating-current motor is a multi-phase motor;
the multi-phase motor is driven by a multi-phase inverter including a plurality of phase circuits;
wherein the one or more processors execute the computer-executable instructions to cause the control device to:
determine a temperature of each of the plurality of phase circuits, and
wherein, when the propeller is locked in a state where the distal direction of the first blade is set to the predetermined direction, in a case where it is determined that the temperature of any one of the plurality of phase circuits is equal to or higher than a predetermined first temperature threshold, the one or more processors cause the control device to perform the rotation control to thereby set the distal direction of the second blade to the predetermined direction, and lock the propeller in a state where the distal direction of the second blade is set to the predetermined direction.

5. The flying object according to claim 4, wherein
the one or more processors execute the computer-executable instructions to cause the control device to:
in a case where a command to generate a yaw moment is issued when the propeller is locked in the state where the distal direction of the first blade is set to the predetermined direction, and in a case where it is determined that the temperature of any one of the plurality of phase circuits is equal to or higher than a second temperature threshold even in a case where it is determined that the temperatures of all of the plurality of phase circuits are lower than the first temperature threshold, perform the rotation control to thereby set the distal direction of the second blade to the predetermined direction and lock the propeller in the state where the distal direction of the second blade is set to the predetermined direction, the second temperature threshold being lower than the first temperature threshold.

6. The flying object according to claim 4, wherein
when the propeller is locked in the state where the distal direction of the first blade is set to the predetermined direction, an amount of heat generated in one phase circuit among the plurality of phase circuits is maximized, and when the propeller is locked in the state where the distal direction of the second blade is set to the predetermined direction, an amount of heat generated in another phase circuit different from the one phase circuit among the plurality of phase circuits is maximized.

7. The flying object according to claim 6, wherein
the one or more processors execute the computer-executable instructions to cause the control device to:
set the distal direction of one of the plurality of blades to the predetermined direction in a manner so that an amount of heat generated in a phase circuit having a largest heat generation amount among the plurality of phase circuits is minimized.

8. The flying object according to claim 1, wherein
the one or more processors execute the computer-executable instructions to cause the control device to:
perform the rotation control to rotate the propeller and, at a same time, perform control to rotate another propeller in a direction opposite to a rotation direction of the propeller, to thereby cancel out torque.

9. The flying object according to claim 1, wherein
the plurality of blades are arranged at unequal angular intervals.

10. A flying object comprising:
a propeller configured to be rotated by an alternating-current motor; and
a control device including one or more processors that execute computer-executable instructions stored in a memory,
wherein
the propeller includes a plurality of blades, and
the propeller has two or more mechanical angles at which air resistance acting on the propeller due to relative wind from a front side of an airframe of the flying object during cruising is minimized, and electrical angles respectively at which the propeller is locked at the two or more mechanical angles are all different from each other,
wherein the one or more processors execute the computer-executable instructions to cause the control device to:
perform rotation control, the rotation control being control that controls electric power supplied to the alternating-current motor to thereby rotate the propeller; and
perform lock control, the lock control being control that maintains a mechanical angle or an electrical angle of the alternating-current motor to thereby lock the propeller, and
wherein, when the lock control is performed after completion of the lock control at a first mechanical angle among the two or more mechanical angles, the one or more processors cause the control device to perform the lock control at a second mechanical angle different from the first mechanical angle.
